(19) United States
(12) Patent Application Publication
(10) Pub. No.: US 2026/0342856 A1
(43) Pub. Date: Oct. 29, 2026

(54) HANDLING UNKNOWN FINGERPRINTS WITH A PROTOCOL-AWARE EDIT DISTANCE

(71) Applicant: Cisco Technology, Inc., San Jose, CA (US)

(72) Inventors: David Arthur McGrew, Poolesville, MD (US); Blake Harrell Anderson, Chapel Hill, NC (US); Andrew Chi, Morrisville, NC (US); Adam Burke Weller, Clarksville, MD (US)

(21) Appl. No.: 19/192,334

(22) Filed: Apr. 29, 2025

(51) Int. Cl. H04L 9/40; G06F 40/205; G06F 40/284

(52) U.S. Cl. CPC H04L 63/20; G06F 40/205; G06F 40/284; H04L 63/0876

(57) ABSTRACT

Techniques for determining, by a network security device, a security policy for a data packet with an unknown fingerprint using protocol-aware edit distance, are described. The network security device intercepts a data packet from a source and determines a fingerprint of the source from the data packet. The network security device compares the fingerprint to a plurality of fingerprints in a fingerprint database and determines whether the fingerprint corresponds to an individual fingerprint of the plurality of fingerprints. Based at least in part on determining that the fingerprint does not correspond to an individual fingerprint of the plurality of fingerprints, the network security device determine a protocol-aware edit distance is within a predetermined threshold protocol-aware edit distance of an individual fingerprint of the plurality of fingerprints and applies a security policy associated with the individual fingerprint to the data packet.

### TECHNICAL FIELD

The present disclosure relates generally to handling unknown fingerprints with a protocol-aware edit distance.

### BACKGROUND

Network security is ever increasing in importance to enterprise organizations for protecting sensitive data from cyber-attacks and ensures that networks remain functional and trustworthy. Preventing unauthorized access, data breaches, and malware is essential. In order to ensure network security, it is important to identify the operating systems (OS) and applications that generate network traffic, especially for malware applications. One conventional approach to identifying an OS and application that generates network traffic is for network security devices, such as firewalls, to use “fingerprints” that are constructed by selecting, normalizing, and serializing data features from network sessions. Network fingerprinting systems rely on exact matches between a fingerprint that is computed from a network session and a set of known fingerprints.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a protocol-aware edit distance may be used to handle unknown fingerprints.

FIG. 2 illustrates a system-architecture diagram of an environment in which an AI model of a firewall may determine a security policy for a source with an unknown fingerprint using protocol-aware edit distance.

FIG. 3 illustrates an example process flow for determining a security policy for a source with an unknown fingerprint.

FIG. 4A illustrates an examples of determining a natural language edit distance between words.

FIG. 4B illustrates an example for determining protocol-aware edit distance between digital fingerprints.

FIG. 5 illustrates a flow diagram for determining a security policy for an unknown source using protocol-aware edit distance.

FIG. 6 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to determining a security policy for a data packet with an unknown fingerprint using protocol-aware edit distance, and may be implemented at least in part by a network security device.

A first method described herein may include intercepting a data packet from a source. Additionally, the first method may include determining a fingerprint of the source from the data packet. The first method may further include comparing the fingerprint to a plurality of fingerprints in a fingerprint database. Further, the first method may include determining whether the fingerprint corresponds to an individual fingerprint of the plurality of fingerprints. Based at least in part on determining that the fingerprint does not correspond to an individual fingerprint of the plurality of fingerprints, the method may also include determining a protocol-aware edit distance is within a predetermined threshold protocol-aware edit distance of an individual fingerprint of the plurality of fingerprints. Finally, the method may include applying a security policy associated with the individual fingerprint to the data packet.

Additionally, the techniques of at least the first method and any other techniques described herein, may be performed by a system and/or device having non-transitory computer-readable media storing computer-executable instructions that, when executed by one or more processors, performs the method(s) described above.

### Example Embodiments

As described above, network security for protecting sensitive data from cyber-attacks and ensuring the network remains functional and trustworthy is of ever-increasing importance to enterprise organizations. A common first line of defense for network security is a firewall. A firewall is a network security device that separates a trusted internal network from external and potentially untrustworthy networks, such as the internet. A firewall can regulate incoming and outgoing network traffic based on preset security rules. Firewalls scrutinize network packets and implement security policies that prevent unauthorized access, data breaches, and malware from infiltrating an enterprise organization's network. In order to identify the operating systems (OS) and applications that generate network traffic, firewalls can use “fingerprints” that are constructed by selecting, normalizing, and serializing data features from network sessions. Conventional firewalls, or other systems that user network fingerprinting typically rely on exact matches between a fingerprint that is computed from a network session and a set of known fingerprints. However, it is infeasible for any set of known fingerprints to incorporate all possible combinations of data features. In addition, it is unreasonable and resource intensive to store more than a set of the most often seen known fingerprints.

This disclosure describes techniques that provide for finding related fingerprints and improving classification in a fingerprinting system. A protocol-aware edit distance is used to find the fingerprint in a known set that is most related to an unknown fingerprint. A protocol-aware edit distance determines the minimum number of operations required to convert one valid protocol message into another valid message of the same protocol. This operation can be applied to raw packets, or to data features extracted from packets. When a fingerprint classifier analyzes a network session, the fingerprint classifier first computes the network protocol fingerprint string from a network packet, the fingerprint string characterizes the sender. If the fingerprint string is known (e.g., found in a database of known fingerprint strings), the system proceeds normally by applying the appropriate security policy (e.g., allow/block) to the packet. However, if the fingerprint is unknown (if there is no matching fingerprint in the database) the fingerprint classifier uses the model associated with the closest fingerprint. The fingerprint classifier can use protocol-aware edit distance to find a fingerprint that is most related to the fingerprint of the data packet. If the minimum protocol-aware edit distance between a fingerprint extracted from a data packet and the closest known related fingerprint exceeds a previously determined threshold, then the potential match is discarded, and the fingerprint classifier does not return any classification results. However, if the most related fingerprint is within the predetermined protocol-aware edit distance, the fingerprint classifier can apply the policy associated with the closest related fingerprint to the packet. In some instances, an entire fingerprint string is compared to an entire known fingerprint strings to determine a protocol-aware edit distance. In other instances, approximate matching on subsections of fingerprint strings may be used, such as matching only cipher suite vectors. In some examples, the unknown fingerprint can then be associated with the closest model, as a way of dynamically extending the known fingerprint set.

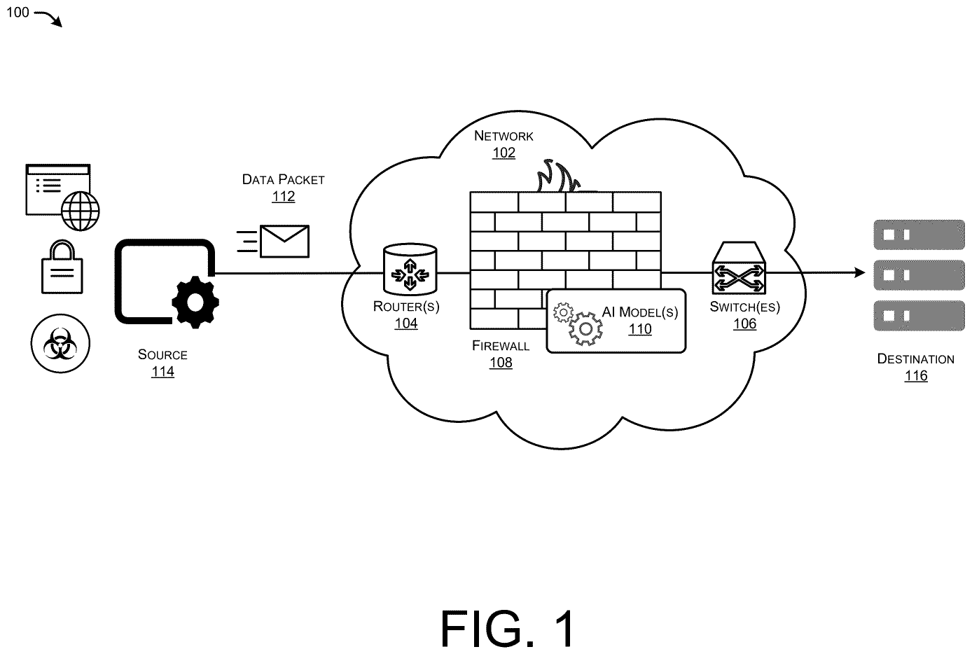

FIG. 1 illustrates a system-architecture diagram of an environment in which a fingerprint classifier in a firewall can be used to determine a security policy for a data packet with an unknown fingerprint.

The environment 100 may include a network 102. The network 102 may be implemented by any viable communication technology, such as wired and/or wireless modalities and/or technologies. The network 102 may be any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network 102 may include devices, virtual resources, or other nodes that relay packets from one network segment to another by nodes in the computer network. The network 102 may include multiple devices that utilize the network layer (and/or session layer, transport layer, etc.) in the OSI model for packet forwarding, and/or other layers. The network 102 may include any number of various network devices, such as routers 104, switches 106, firewall 108 as well as other network devices not illustrated, gateways, smart NICs, NICs, ASICs, FPGAs, servers, and/or any other type of device. Further, the network 102 may include virtual resources, such as VMs, containers, and/or other virtual resources. However, the network 102 may be of a different type of architecture, such as a WAN, IoT network, cellular network, or any other type of network.

In Environment 100, the firewall 108 may include one or more AI model(s) 110 that assist in monitoring and controlling incoming and outgoing traffic in network 102. The firewall 108, including AI model(s) 110 may allow or block incoming and outgoing data traffic based on a predefined set of security rules to prevent unauthorized access to network 102. The AI model(s) 110 may include a fingerprint classifier that analyzes a network session, computes a network protocol fingerprint string from a network packet, such as data packet 112 sent from source 114 to destination 116. The fingerprint string characterizes the sender, source 114. If the fingerprint string is known the fingerprint classifier proceeds normally by applying the appropriate security policy (e.g., allow/block) to the data packet 112. However, if the fingerprint is unknown the fingerprint classifier may use the model associated with the closest related fingerprint. The fingerprint classifier can use protocol-aware edit distance to find a fingerprint that is most related to the fingerprint of data packet 112. If the minimum distance exceeds a previously determined threshold, then the potential match is discarded, and the fingerprint classifier does not return any classification results. However, if the most related fingerprint is within the predetermined protocol-aware edit distance, the fingerprint classifier can apply the policy associated with the closest related fingerprint to the data packet 112. In some instances, the fingerprint classifier may also associate the fingerprint from the data packet 112 with the source of the closest related fingerprint and store the association for future reference.

As an example, a particular application that is authorized to generate and send data traffic through network 102 may alter its digital fingerprint for some legitimate reason (e.g., result of a software update). Thus, when firewall 108 inspects data packet 112 sent by the application, the AI model(s) 110 will not have an exact fingerprint match for the data packet 112. However, using protocol-aware edit distance, the fingerprint classifier can determine that the data packet 112 is within a predetermined edit distance to a known fingerprint of the application and apply the security policy associated with the application to the data packet 112. In addition, is some examples, the unknown fingerprint of data packet 112 can be associated with the application and added to the known set of fingerprints associated with that application. Alternately, a particular malware application may alter its digital fingerprint for malicious purposes (e.g., previous fingerprints is a known malware fingerprint and blocked by the network). In this situation, when firewall 108 inspects data packet 112 sent by the malware, the firewall will not have an exact fingerprint match, however using protocol-aware edit distance, it can likely be determined that the source of the data packet 112 is malware, data packet 112 can be blocked form entering the network 102, and the new fingerprint can be stored as a known fingerprint of the malware for subsequent reference.

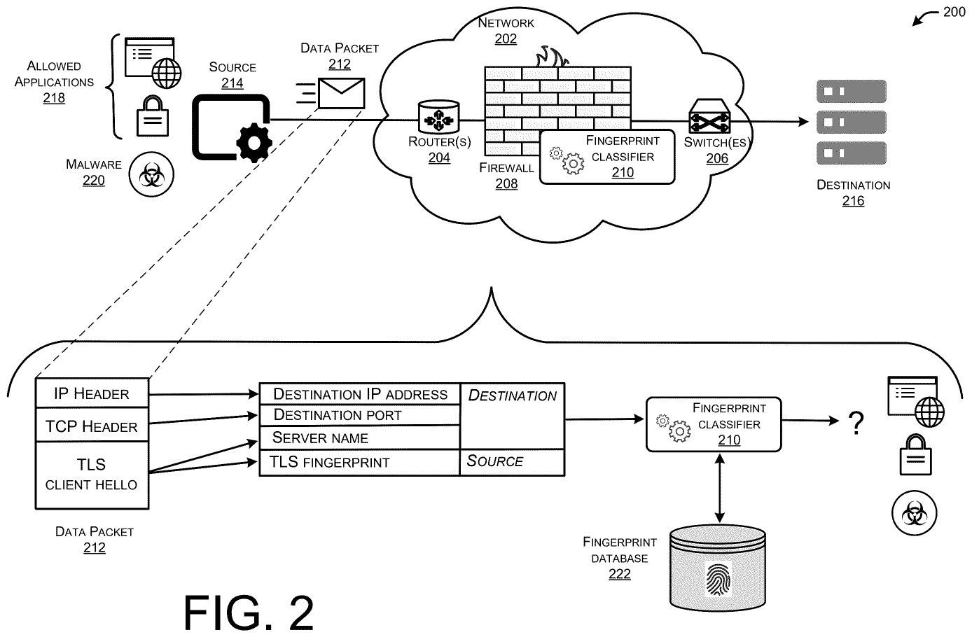

FIG. 2 illustrates a system-architecture diagram of an environment in which a fingerprint classifier of a firewall may determine a security policy for a source with an unknown fingerprint using protocol-aware edit distance.

Environment 200 may include a network 202. The network 202 may be similar to network 102 as described with reference to FIG. 1 and includes any number of network devices such as router(s) 204, switch(es) 206, firewall 208, and various other network devices. In environment 200, the firewall 208 may include a fingerprint classifier 210. Fingerprint classifier 210 may be one of the AI model(s) 110 deployed to firewall 108 as illustrated in FIG. 1. Fingerprint classifier 210 may assist in monitoring and controlling incoming and outgoing traffic in network 202. Fingerprint classifier 210 may analyzes a network session, compute a network protocol fingerprint string from a network packet, such as data packet 212 sent from source 214 to destination 216. The fingerprint string characterizes the sender, source 214. If the fingerprint string is a known fingerprint the firewall proceeds normally by applying the appropriate security policy (e.g., allow/block) to the data packet 212. For Example, if the fingerprint in data packet 212 is a fingerprint of one of the allowed applications 218, firewall 208 will allow the data packet 212 into network 202. However, if the fingerprint in data packet 212 is a fingerprint of a known malware 220, firewall 208 will block data packet 212 from entering network 202.

Conventional network security systems that use digital fingerprints to determine a security policy to apply to a data packet, typically rely on exact fingerprint matching. In other words, in order to determine a security policy for a data packet, a fingerprint in the data packet must match a fingerprint known by the security system exactly. As described above, when a data packet contains a fingerprint of a known allowed application 218, the firewall 208 will allow the data packet to enter the network 202. However, when the data packet contains a fingerprint of known malware 220, the firewall 208 will block the data packet from entering the network 202.

However, it is infeasible for any set of known fingerprints to incorporate all possible combinations of data features. Further, it is resource prohibitive to store more than a set of most often seen fingerprint in a network security system. Additionally, there are many legitimate reasons why a non-malicious source that may have previously been authorized to send data packets through a network, may slightly alter their digital fingerprint (e.g., software updates). This results in the network security system not having the new fingerprint in the systems as a known fingerprint. Additionally, malicious sources may often alter their digital fingerprint for purposes of evading detection. To ensure efficient network functioning, the network security system needs to be able to identify these slight variations in fingerprints as either allowable network data packets, or data packets that must be blocked. Moreover, once these slight variations have been identified as being associated with an allowed application 218 or malware 220, the associations can be stored in the security system form future reference.

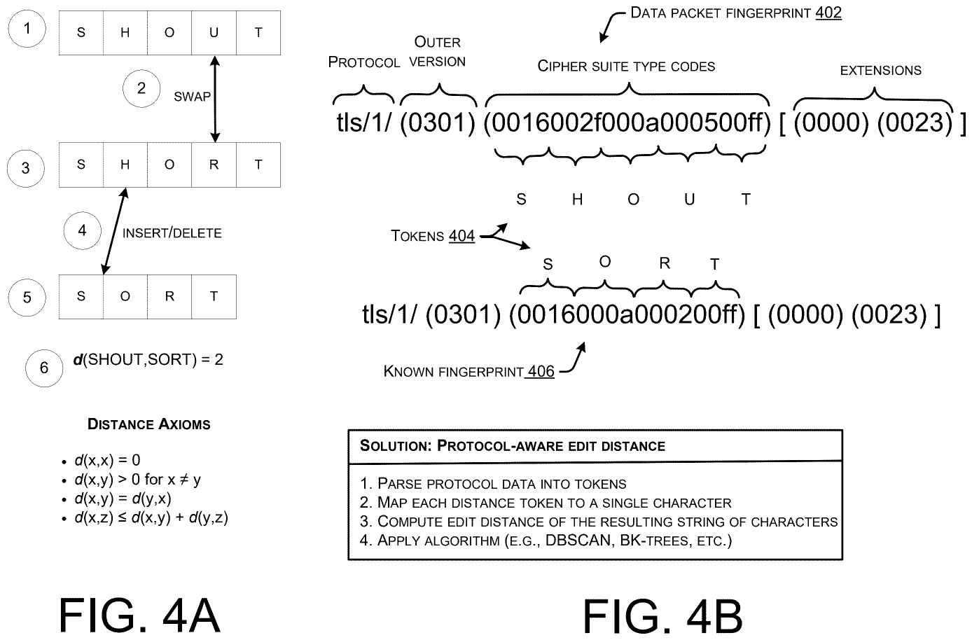

Environment 200 includes firewall 208 with fingerprint classifier 210 to address how to determine a security policy to apply to data packets that contain a fingerprint that does not exactly match a known fingerprint in the system. When data packet 212 enters network 202, firewall 208 intercepts data packet 212 for inspection. As illustrated data packet 212 is a Transport Layer Security (TLS) client hello (this is by example and not limitation). The TLS fingerprint may be determined from the data packet 212 and compared to fingerprints in fingerprint database 222. Fingerprint database 222 stores a set of known fingerprints and their associated security policies. When there is no exact match between the fingerprint in data packet 212 and a known fingerprint in fingerprint database 222, the fingerprint classifier 210 may find a fingerprint or set of fingerprints that are a closest match and determine a protocol-aware edit distance between the fingerprint in data packet 212 and the closest known fingerprint(s) is fingerprint database 222. Protocol-aware edit distance is explained in greater detail below with reference to FIG. 4B. If the protocol-aware edit distance between the fingerprint in data packet 212 and the known fingerprint in database 222, is within a predetermined threshold distance, fingerprint classifier 210 can determine that the fingerprint in data packet 212 is likely associated with the closest related known fingerprint, thus applying a security policy (e.g., allow/block) associated with the closest known fingerprint to data packet 212 is appropriate. For example, if the protocol-aware edit distance between the fingerprint in data packet 212 and a fingerprint associated with one of the allowed applications 218 is within a predetermined threshold protocol-aware edit distance, then the firewall 208 can determine that data packet 212 likely came from an allowed application 218, and firewall 208 will allow data packet into the network 202. On the other hand, if the protocol-aware edit distance between the fingerprint in data packet 212 and a fingerprint associated with a known malware 220 is within a predetermined threshold protocol-aware edit distance, then the firewall 208 can determine that data packet 212 likely came from malware 220 and firewall 208 will block data packet 212 from entering network 202.

In some instances, an entire fingerprint string is compared to an entire known fingerprint strings to determine a protocol-aware edit distance. In other instances, approximate matching on subsections of fingerprint strings may be used, such as matching only cipher suite vectors of the fingerprint from data packet 212 and a closest known fingerprint form fingerprint database 222. In some examples, the unknown fingerprint can then be associated with the closest model, as a way of dynamically extending the known fingerprint set. If the protocol-aware edit distance between the fingerprint form data packet 212 and the closest related fingerprint in fingerprint database 222 is greater than the predetermined threshold distance, then the potential match is discarded and the fingerprint classifier 210 does not return any classification results.

The fingerprint classifier 210 may be a type of machine learning (ML) model or other artificial intelligence (AI) model deployed to firewall 208. Fingerprint classifier 210 may be a ML classifier that categorizes data into classes. A classifier is a type of ML algorithm used to assign a class label to a data input. A classifier may generate predictions about the likelihood of a data input being classified in a certain way. A classifier ML model may be supervised or unsupervised. A supervised classifier is a model trained using labeled data and after training it can make predictions on unlabeled data based on patterns learning from labeled examples. An unsupervised classifier is trained on unlabeled data and has no predefined labels or categories to guide it. Unsupervised classifiers use pattern recognition to identify groups or outliers. Fingerprint classifier 210 may be a supervised or unsupervised classifier. Fingerprint classifier 210 may be any available type of appropriate classifier such as, but not limited to, a decision tree, artificial neural network (ANN), naïve bayes classifier, support vector machine (SVM), k-nearest neighbor (KNN), etc. Fingerprint classifier 210 may be trained on network specific data, and fine-tuned on digital fingerprints. Fingerprint classifier may be trained on hundreds of thousands of fingerprints. Training data may include fingerprints from operational network, malware sandbox traffic, and other sources, and may be continuously updated with new fingerprints. Thus, the accuracy of the fingerprint classifier may be improved by creating clusters of fingerprints that are associated with similar applications and behaviors. When ground truth and an OS and application associated with a fingerprint is available, it can be used to create the clusters. However, some fingerprints do not have ground truth, and other approaches may be used to find close matches.

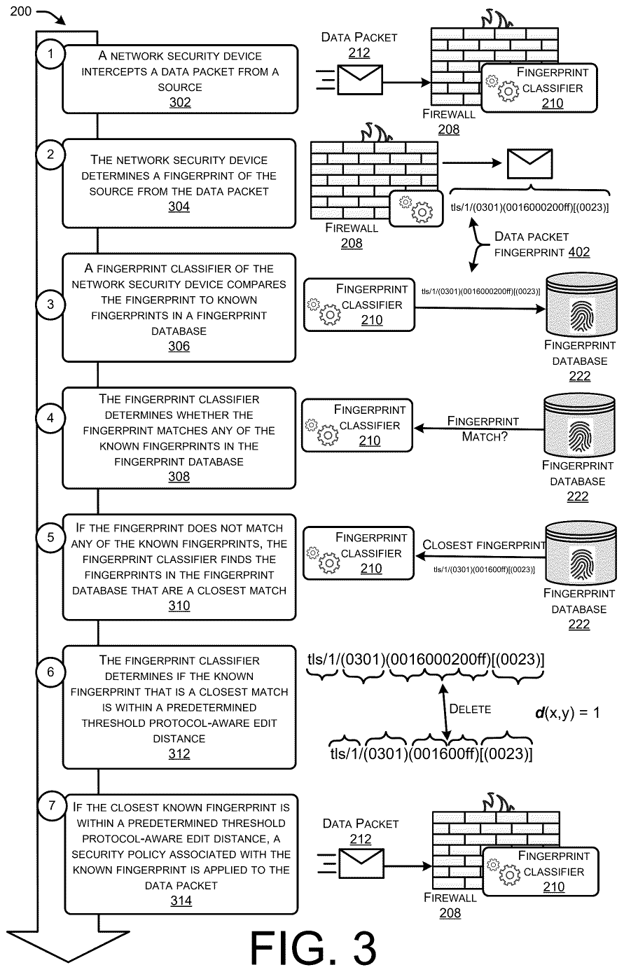

FIG. 3 illustrates an example process flow for determining a security policy for a data packet from a source with an unknown fingerprint.

At 302, a network security device intercepts a data packet from a source. For example, with reference to FIG. 2 when a data packet 212 sent from source 214 attempts to enter network 202, firewall 208 can intercept data packet 212 for inspections to determine a security policy that should be applied to data packet 212. The firewall 208 decides whether to permit or block the data packet 112 based on pre-set rules. The firewall effectively applies an appropriate security policy to bar unauthorized users or potentially harmful data from infiltrating the network 202.

At 304, the network security device determines a fingerprint of the source from the data packet. For example, with reference to FIG. 2 the firewall 208 intercepts data packet 212 and the fingerprint classifier 210 extracts a fingerprint string associated with the source from the data packet 212. As illustrated in FIG. 2 the data packet 212 may be a TLS client hello, or it may be a different protocol. With reference to FIG. 4B and the corresponding description below, the fingerprint string may be a TLS fingerprint such as data packet fingerprint 402. Note a TLS fingerprint is shown and described herein as an example and not meant to be limiting. The techniques described here for using protocol-aware edit distance may be applied to any appropriate protocol (e.g., HTTP, QUIC, STUN, etc.)

At 306, a fingerprint classifier of the network security device compares the fingerprint to known fingerprints in a fingerprint database. For example, with reference to FIG. 2 the fingerprint classifier 210 of the firewall 208 compares the fingerprint string extracted from data packet 212 to known fingerprints stored in fingerprint database 222. Fingerprint database 222 may contain tens of thousands (or more or less) of the most often encountered fingerprints and the security policy associated with these fingerprints so the firewall knows whether to allow or block a packet with one of the stored fingerprints. In some examples, fingerprint classifier 210 of the firewall 208 may compare an entire fingerprint string from data packer 212 to the entire known fingerprint strings store in fingerprint dataset 222. Alternately, fingerprint classifier 210 may compare only a certain portion of the fingerprint string extracted from data packet 212 to the corresponding portion of known fingerprint stored in fingerprint database 222. For example, the fingerprint classifier 210 may only look for matches of the cipher suite vector as illustrated and described with reference to FIG. 4B below.

At 308, the fingerprint classifier determines whether the fingerprint matches any of the known fingerprints in the fingerprint database. For example, with reference to FIG. 2 the fingerprint classifier 210 of firewall 208 determines whether the fingerprint string extracted from data packet 212 matches any of the fingerprints stored in fingerprint data 222. If there is an exact fingerprint match in fingerprint database 222, the firewall 208 will simply apply the appropriate security policy to the data packet 212 (e.g., allow or block the packet). For example, if the data packet 212 originated from an allowed application 218, and the data packet 212 contains a fingerprint that matches a known fingerprint, associated with the allowed application 218, in the fingerprint database, the firewall 208 allows the data packet 212. However, if the data packet 212 originated from a known malware 220, and the data packet 212 contains a fingerprint that matches a known fingerprint in the fingerprint database associated with malware 220, the firewall 208 will block the data packet 212 from entering the network 202.

At 310, if the fingerprint does not match any of the know fingerprints, the fingerprint classifier finds the fingerprint(s) in the fingerprint database that are a closest match. For example, with reference to FIG. 2, the fingerprint classifier 210 determines that the fingerprint string extracted from data packet 212 does not match exactly any of the known fingerprints stored in the fingerprint database 222. The fingerprint classifier 210 then looks for fingerprints that are closest matches to the fingerprint string extracted from data packet 212. The fingerprint classifier may find one or many known fingerprints in fingerprint database 222 that are a close match to the fingerprint in data packet 212. In some examples, the fingerprint classifier looks for an exact match of the entire fingerprint string. In other examples, the fingerprint classifier looks for exact matches of only particular portion of the fingerprint string, for example, a cipher suite vector.

At 312, the fingerprint classifier determines if the known fingerprint that is a closest match is within a predetermined threshold protocol-aware edit distance. For example, as described below with reference to FIG. 4B, the protocol-aware edit distance between data packet fingerprint 402 and known fingerprint 406 is two. The fingerprint classifier 210 determines whether a protocol-aware edit distance of two is within an acceptable predetermined threshold. To determine protocol-aware edit distance, the number of substitutions, or edits is determined, but only substitution that are valid for the specific protocol are allowed. In other words, turning one valid protocol message into another valid protocol message as described in further detail below with reference to FIG. 4B.

At 314, if the closest known fingerprint is within a predetermined threshold protocol-aware edit distance, a security policy associated with the known fingerprint is applied to the data packet. For example, with reference to FIG. 2, when fingerprint classifier 210 determines that a known fingerprint in fingerprint database 222 is within a predetermined threshold protocol-aware edit distance from the fingerprint in data packet 212, the firewall 208 applies a security policy associated with the know fingerprint to data packet 212. For example, if the known fingerprint is associated with an allowed application 218, the firewall 208 can allow data packet 212 to proceed through network 202. If the known fingerprint is from malware 220, the firewall 208 can block the data packet 212 from network 202.

FIGS. 4A and 4B illustrate examples of edit distance. Edit distance is a string metric, in other words a way to quantify how dissimilar two strings are to one another, by counting the minimum number of operations required to transform one string into the other.

FIG. 4A specifically illustrates a natural language example of determining an edit distance. At (1) the example begins with the word SHOUT. At (2) the letter “U” is swapped for the letter “R” to become the work SHORT at (3). At (4) the letter “H” is deleted to become the word SORT at (5). Thus, as shown at (6) the edit distance between the word SHOUT and SORT is two because the number of operations to transform SHOUT to SORT is two. As illustrated, an edit may be swapping one letter for another, or adding or deleting a letter.

FIG. 4B illustrates an example of protocol-aware edit distance. To determine protocol-aware edit distance, the number of substitutions, or edits is determined, but only substitutions that are valid for the specific protocol are allowed. In other words, turning one valid protocol message into another valid protocol message. Note the fingerprint strings illustrated in FIG. 4B are used as examples and not meant to depict actual TLS fingerprint strings. Additionally, although TLS is used here for example purposes, the technique described herein are not limited to TLS and may be applied to any appropriate protocol (e.g., QUIC, HTTP, STUN, etc.).

In FIG. 4B a data packet is inspected having a data packet fingerprint 402. For example, data packet 212 in FIG. 2 may be inspected by firewall 208 that includes fingerprint classifier 210. The protocol data in data packet fingerprint 402 is parsed into tokens and each token is mapped to a single character as illustrated by tokens 404. Note, in FIG. 4B only the cipher suite vector is tokenized and compared to known fingerprints, this is by example and not meant to be limiting. Any or all parts of the fingerprint may be used to determine protocol-aware edit distance. As the TLS cipher suite is in hexadecimal, each hexadecimal byte in the cipher suite is tokenized and assigned a single character. The resulting string of characters is used to compute the protocol-aware edit distance to a known fingerprint 406. Referring back to FIG. 4A, the edit distance between SHOUT and SORT is two. Thus, the protocol-aware edit distance between data packet fingerprint 402 and known fingerprint 406 is two. Note, the tokenization illustrated is used for example purposes and not meant to be limiting, characters assigned to each byte in a cipher suite may be similar or different than illustrated. If two is within a predetermined acceptable protocol-aware edit distance, a security policy associated with known fingerprint 406 may be applied to the data packet with data packet fingerprint 402. In addition, in some instances when the protocol-aware edit distance is within the predetermined threshold, the data packet fingerprint 402 can dynamically be associated with the source of the known fingerprint 406 and the association store in the system for future reference.

In some instances, algorithms such as DBSCAN, BK-Trees, etc. may be applied to increase the speed of fingerprint lookups or approximate fingerprint matching, either in real time or during offline analysis to understand how data from different fingerprints relate to each other, how large or small a predetermined threshold protocol-aware edit distance should be, and the like.

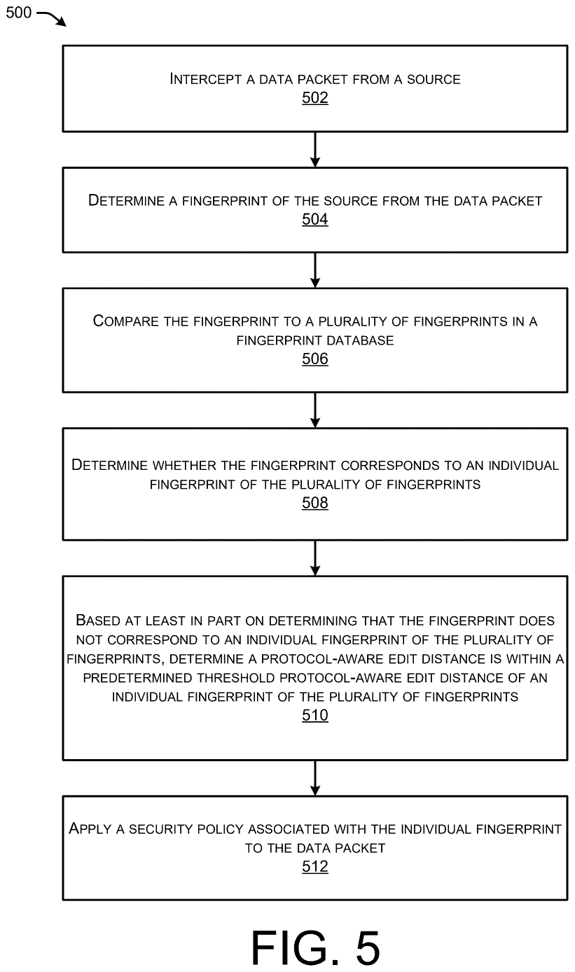

FIG. 5 illustrates a flow diagrams of an example method 500 that illustrates aspect of the functions performed at least partly by the devices described in FIGS. 1-4, such as the firewall 108 that includes AI model(s) 110. The logical operations described herein with respect to FIG. 5 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 5 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 500 may be performed by a device and/or a system of devices that includes one or more processors and one or more non-transitory computer-readable media storing computer-executable instructions that, when executed by the one or more processors, cause the one or more processors to perform operations of method 500.

FIG. 5 illustrates a flow diagram of an example method 500 for determining a security policy for a source with an unknown fingerprint.

At operation 502, a network security device intercepts a data packet from a source. For example, with reference to FIG. 1, the firewall 108 may intercept data packet 112 sent from source 114 to destination 116. The firewall 108 intercepts the data packet 112 that is entering network 102 to determine whether the source 114 can be trusted. The firewall 108 may scrutinize the data packet 112 and decide whether to permit or block the data packet 112 based on pre-set rules. The firewall effectively applies an appropriate security policy to bar unauthorized users or potentially harmful data from infiltrating the network 102.

At operation 504, the security device determines a fingerprint of the source from the data packet. For example, with reference to FIG. 2 the firewall 208 intercepts data packet 212 and the fingerprint classifier 210 extracts a fingerprint string associated with the source from the data packet 212. With reference to FIG. 4B, the fingerprint string may be data packet fingerprint 402.

At operation 506, the network security device compares the fingerprint to a plurality of fingerprints in a fingerprint database. For example, with reference to FIG. 2 the fingerprint classifier 210 of the firewall 208 compares the fingerprint string extracted from data packet 212 to known fingerprints in stored in fingerprint database 222. Fingerprint database 222 may contain tens of thousands (or more or less) of the most often encountered fingerprints and the security policy associated with these fingerprints so the firewall knows whether to allow or block a packet with one of the stored fingerprints.

At operation 508, the network security device determines whether the fingerprint corresponds to an individual fingerprint of the plurality of fingerprints. For example, with reference to FIG. 2 the fingerprint classifier 210 of firewall 208 determines whether the fingerprint string extracted from data packet 212 matches any of the fingerprints stored in fingerprint data 222. If there is an exact fingerprint match in fingerprint database 222, the firewall 208 will simply apply the appropriate security policy to the data packet 212 (e.g., allow or block the packet). For example, if the data packet 212 originated from an allowed application 218, and the data packet 212 contains a fingerprint that matches a known fingerprint in the fingerprint database, the firewall 208 allows the data packet 212.

At operation 510, based at least in part on determining that the fingerprint does not correspond to an individual fingerprint of the plurality of fingerprints, determine a protocol-aware edit distance is within a predetermined threshold protocol-aware edit distance of an individual fingerprint of the plurality of fingerprints. For example, with reference to FIG. 2, the fingerprint classifier 210 determines that the fingerprint string extracted from data packet 212 does not match exactly any of the known fingerprints stored in the fingerprint database 222. The fingerprint classifier 210 then looks for fingerprints that are a closest match to the fingerprint string extracted from data packet 212. Once the fingerprint classifier 210 finds the closest known fingerprint(s) to the fingerprint in the data packet 212, the fingerprint classifier determines a protocol-aware edit distance from the fingerprint of data packet 212 to the closest known fingerprint stored in fingerprint database 222. For example, with reference to FIG. 4B, the protocol-aware edit distance between data packet fingerprint 402 and known fingerprint 406 is two. The fingerprint classifier 210 determines that a protocol-aware edit distance of two is within an acceptable predetermined threshold.

At operation 512, once the network security device determines that a known fingerprint is within an acceptable predetermined threshold distance to the fingerprint for the data packet the network security device applies a security policy associated with the individual fingerprint to the data packet. For example, with reference to FIG. 2, when fingerprint classifier 210 determines that a known fingerprint in fingerprint database 222 is within a predetermined threshold protocol-aware edit distance from the fingerprint in data packet 212, the firewall 208 applies a security policy associated with the know fingerprint to data packet 212. For example, if the known fingerprint is associated with an allowed application 218, the firewall 208 can allow data packet 212 to proceed through network 202. If the known fingerprint is from malware 220, the firewall 208 can block the data packet 212 from network 202.

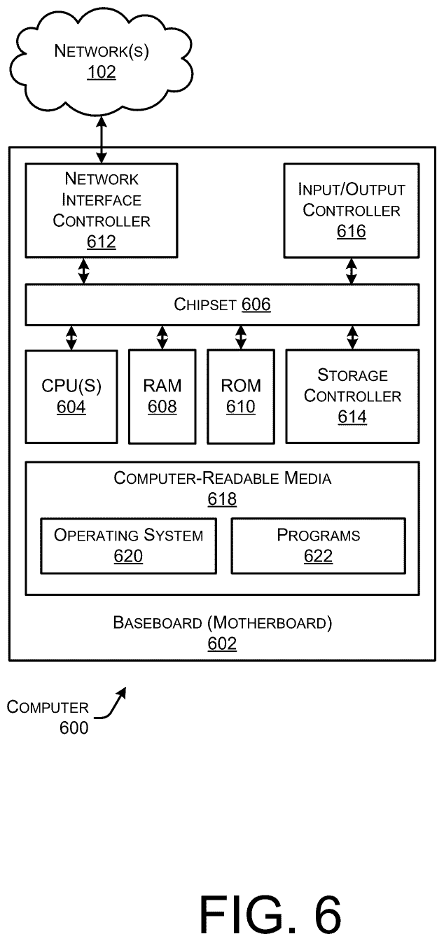

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein.

As described herein, the computer 600 may be any type of device, such as network devices like router(s) 104, switch(es) 106, firewall 108, a client device like source 114, and a destination device like destination 116. Thus, the computer 600 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network 102 or network 202. The chipset 606 can include functionality for providing network connectivity through a NIC 612, such as a gigabit Ethernet adapter. The NIC 612 is capable of connecting the computer 600 to other computing devices over the network 102. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the routers 104, switches 106, firewall 108, source 114, destination 116, and or any components included therein, may be supported by one or more devices similar to computer 600. Stated otherwise, some or all of the operations performed by the routers 104, switches 106, firewall 108, source 114, destination 116, and or any components included therein, may be performed by one or more computer devices 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in the Figures, can include other components that are not explicitly shown in FIG. 6, or might utilize an architecture completely different than that shown in FIG. 6.

As described herein, the computer 600 may comprise one or more of the router(s) 104, switch(es) 106, firewall 108, source 114, destination 116, and/or any other device. The computer 600 may include one or more hardware processors 604 (processors) configured to execute one or more stored instructions. The processor(s) 604 may comprise one or more cores. Further, the computer 600 may include one or more network interfaces configured to provide communications between the computer 600 and other devices, such as the communications described herein as being performed by the router(s) 104, switch(es) 106, firewall 108, source 114, destination 116. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method, implemented at least in part by a network security device, for determining a security policy for a data packet with an unknown fingerprint, the method comprising:
intercepting the data packet from a source;
determining a fingerprint of the source from the data packet;
comparing the fingerprint to a plurality of fingerprints in a fingerprint database;
determining whether the fingerprint corresponds to an individual fingerprint of the plurality of fingerprints;
based at least in part on determining that the fingerprint does not correspond to an individual fingerprint of the plurality of fingerprints, determining a protocol-aware edit distance is within a predetermined threshold protocol-aware edit distance of an individual fingerprint of the plurality of fingerprints; and
applying a security policy associated with the individual fingerprint to the data packet.

2. The method of claim 1 further comprising associating the fingerprint of the source to a source of the individual fingerprint of the plurality of fingerprints and storing the association in the fingerprint database.

3. The method of claim 1, further comprising:
parsing protocol data of the fingerprint into tokens;
mapping each token to a single character to form a character string; and
computing an edit distance between the character string and a character string of tokens associated with the individual fingerprint of the plurality of fingerprints.

4. The method of claim 1, wherein the data packet is a Transport Layer Security (TLS) Client Hello.

5. The method of claim 1, wherein a portion of the fingerprint is compared to a same portion of plurality of fingerprints in the fingerprint database.

6. The method of claim 5, wherein the portion of the fingerprint is a cipher suite vector of a Transport Layer Security (TLS) Client Hello.

7. The method of claim 1, wherein a machine learning (ML) model, trained on data sets of fingerprints from at least one of operational networks and malware sandbox traffic is deployed to the network security device.

8. A system comprising:
one or more processors; and
one or more computer-readable media storing computer-executable instructions that, when executed by the one or more processors, cause the one or more processors to perform operations comprising:
intercepting, by a network security device, a data packet from a source;
determining, by the network security device, a fingerprint of the source from the data packet;
comparing, by the network security device, the fingerprint to a plurality of fingerprints in a fingerprint database;
determining, by the network security device, whether the fingerprint corresponds to an individual fingerprint of the plurality of fingerprints;
based at least in part on determining that the fingerprint does not correspond to an individual fingerprint of the plurality of fingerprints, determining, by the network security device, a protocol-aware edit distance is within a predetermined threshold protocol-aware edit distance of an individual fingerprint of the plurality of fingerprints;
and
applying, by the network security device, a security policy associated with the individual fingerprint to the data packet.

9. The system of claim 8, the operations further comprising associating, by the network security device, the fingerprint of the source to a source of the individual fingerprint of the plurality of fingerprints and storing the association in the fingerprint database.

10. The system of claim 8, the operations further comprising:
parsing protocol data of the fingerprint into tokens;
mapping each token to a single character to form a character string; and
computing an edit distance between the character string and a character string of tokens associated with the individual fingerprint of the plurality of fingerprints.

11. The system of claim 8, wherein the data packet is a Transport Layer Security (TLS) Client Hello.

12. The system of claim 11, wherein a portion of the fingerprint is compared to a same portion of plurality of fingerprints in the fingerprint database.

13. The system of claim 12, wherein the portion of the fingerprint is a cipher suite vector of a Transport Layer Security (TLS) Client Hello.

14. The system of claim 8, wherein a machine learning (ML) model, trained on data sets of fingerprints from at least one of operational networks and malware sandbox traffic is deployed to the network security device.

15. One or more non-transitory computer-readable media storing instructions that, when executed, cause one or more processors to perform operations comprising:
intercepting, by a network security device, a data packet from a source;
determining, by the network security device, a fingerprint of the source from the data packet;
comparing, by the network security device, the fingerprint to a plurality of fingerprints in a fingerprint database;
determining, by the network security device, whether the fingerprint corresponds to an individual fingerprint of the plurality of fingerprints;
based at least in part on determining that the fingerprint does not correspond to an individual fingerprint of the plurality of fingerprints, determining, by the network security device, a protocol-aware edit distance is within a predetermined threshold protocol-aware edit distance of an individual fingerprint of the plurality of fingerprints; and
applying, by the network security device, a security policy associated with the individual fingerprint to the data packet.

16. The one or more non-transitory computer-readable media of claim 15, the operations further comprising associating, by the network security device, the fingerprint of the source to a source of the individual fingerprint of the plurality of fingerprints and storing the association in the fingerprint database.

17. The one or more non-transitory computer-readable media of claim 15, the operations further comprising:
parsing protocol data of the fingerprint into tokens;
mapping each token to a single character to form a character string; and
computing an edit distance between the character string and a character string of tokens associated with the individual fingerprint of the plurality of fingerprints.

18. The one or more non-transitory computer-readable media of claim 15, wherein the data packet is a Transport Layer Security (TLS) Client Hello.

19. The one or more non-transitory computer-readable media of claim 18, wherein a portion of the fingerprint is compared to a same portion of plurality of fingerprints in the fingerprint database.

20. The one or more non-transitory computer-readable media of claim 19, wherein the portion of the fingerprint is a cipher suite vector of a Transport Layer Security (TLS) Client Hello.
